(19) United States
(12) Patent Application Publication
(10) Pub. No.: US 2009/0025173 A1
(43) Pub. Date: Jan. 29, 2009

(54) ROTATION CONTROL MECHANISM ESPECIALLY FOR A WINDOW WIPING DEVICE PERTAINING TO A MOTOR VEHICLE

(75) Inventors: Marcel Trebouet, St Nom La Breteche (FR); Franck Cathala, St. Martin Laguepie (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES D'ESSUYAGE, La Verriere (FR)

(21) Appl. No.: 12/162,488

(22) PCT Filed: Feb. 7, 2007
(86) PCT No.: PCT/EP07/51176

§ 371 Date: Jul. 29, 2008

(30) Foreign Application Priority Data
Feb. 13, 2006 (FR) 0601261

(51) Int. Cl. B60S 1/34; F16H 25/18; F16H 21/54

(52) U.S. Cl. 15/250.34; 74/102

(57) ABSTRACT

A rotation control mechanism including a primary shaft driven in an alternating axially rotating manner, a drive carrier fixed to the primary shaft, a secondary shaft mounted in an axially rotatable manner in relation to the drive carrier, a fixed cam provided with a specific profiled element, and a control element which is fixed to the secondary shaft and cooperates in a sliding manner with the cam profiled element during the displacement of the drive carrier in relation to the fixed cam, where the sliding of the control element along the cam profiled element control the axial pivoting of the secondary shaft.

The present invention relates to a mechanism designed, on the one hand, to drive a secondary shaft in alternating rotation about a primary shaft and, on the other hand, to control the axial pivoting on the latter of said secondary shaft.

The invention has an interesting but not exclusive application in the field of wiping systems for motor vehicle windscreens.

Nowadays, motor vehicle manufacturers want to equip vehicles with windscreens having complex or panoramic surfaces, which have the characteristic of comprising lateral portions with strong curvatures.

In order to obtain optimum wiping quality on such complex surfaces, it is known to use windscreen-wiper systems implementing windscreen-wiper blade assemblies with variable angles of incidence. With this type of device the actual tilt of the blade assembly in relation to the perpendicular of the windscreen surface changes according to the angular position of the associated blade-holding arm. This characteristic makes it possible to comply with the recommended angle of incidence throughout the entire wiping cycle.

The wiping devices of the state of the art which have this function, generally comprise a blade-holding arm which is mounted mobile in an axially rotatable manner, with its displacement controlled by control means maximising the primary wiping movement of the system.

Such control means can be presented mainly in the form of a wiper fixed to the blade-holding arm, which can cooperate by sliding with a fixed cam whose profile extends in the three dimensions of space.

This type of arrangement, however, has the disadvantage of being particularly bulky, in particular its height, precisely due to the three-dimensional shape of the cam. Its use is furthermore limited to relatively progressive corrections, which is of relatively little use in the case of a windscreen with a complex or panoramic surface, which instead requires quick variations of the angle of incidence when the wiping blade assembly reaches one of the highly curved lateral edges.

In order to overcome these difficulties, control means have been developed which use a much less bulky flat cam, connected to a mechanism converting the linear movement conventionally generated by said cam into a rotating movement which can be transmitted to the blade-holding arm.

However, this type of embodiment still has considerable disadvantages relating essentially to its great structural complexity. The movement conversion mechanism actually requires the use and cooperation of a very large number of parts.

A first consequence is that such a system is ultimately extremely expensive, due to the cumulative value of the intrinsic costs of the various parts, but also due to the additional assembly costs implied by the large number of parts involved.

Another disadvantage of this second embodiment lies in the fact that the control means are also excessively bulky, even if this bulk is mostly in the lengthwise direction. The movement conversion mechanism must in fact be installed along the axis of the blade-holding arm.

One final disadvantage inherent in the large number of parts and therefore of joints used relates to the inevitable appearance of geometric dispersion problems, which can result in malfunctions and even in irreversible damage.

Also, the technical problem to be solved by the present invention is to provide a rotation control mechanism that can overcome the problems of the state of the art by becoming substantially less expensive to manufacture and having reduced bulk.

The solution to the technical problem posed consists, according to the invention, in that the rotation control mechanism comprises:
a primary shaft that can be driven in an alternating axially rotating manner,
a drive carrier fixed to the primary shaft,
a secondary shaft mounted in an axially rotatable manner in relation to the drive carrier,
a fixed cam provided with a specific profiled element,
a control element which is fixed to the secondary shaft and can cooperate in a sliding manner with the cam profiled element during the displacement of the drive carrier in relation to the fixed cam,

and in that the sliding of the control element along the cam profiled element can control the axial pivoting of the secondary shaft.

It should be noted that, throughout this text, the term “profiled element” designates in very general terms the active surface of the cam, whether this is, for example, its outer surface or an inner contour delimiting a through groove.

In any event, the invention as defined has the advantage of having a relatively simple structure compared with the rotation control mechanisms of the state of the art.

The cam of the invention is not conventionally used to transform a rotation movement into a linear movement, knowing that this linear movement must then be necessarily converted into a rotating movement in order to be transmitted to the blade-holding arm. The cam of the invention is actually used to generate a pivoting movement of the control element, which then directly drives the axial rotation movement of the blade-holding arm.

This is a much more simple operating principle than those of the prior art, which means that its implementation requires considerably fewer parts. This results in considerable gains in terms of manufacturing costs, whether as regards the intrinsic cost of each element that makes up the mechanism or the intrinsic cost of assembly.

The combination of a flat cam and a directly adjacent control element also makes it possible to limit the size of the rotation control mechanism. The latter can then offer optimal compactness in order to favour its integration, for example, in a wiping device for a motor vehicle windscreen.

The present invention also relates to the characteristics that will emerge throughout the following description, which should be considered on their own or in any possible technical combination.

This description, given by way of non-limiting example, aims to provide a clearer understanding of what the invention consists of and how it can be implemented. It is also made in reference to the appended drawings, wherein:

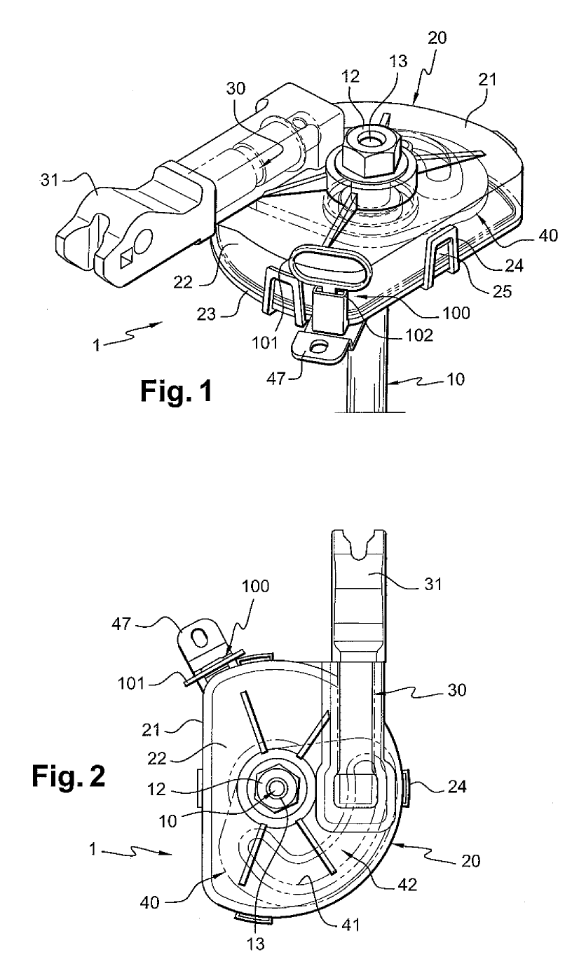

FIG. 1 is a transparent top perspective view partially showing a wiping device integrating a rotation control mechanism according to a first embodiment of the invention.

FIG. 2 is a top view showing the wiping device of FIG. 1 in a so-called fixed stop position.

FIG. 3 is a view similar to that in FIG. 2, but with the wiping device is a so-called opposite fixed stop position.

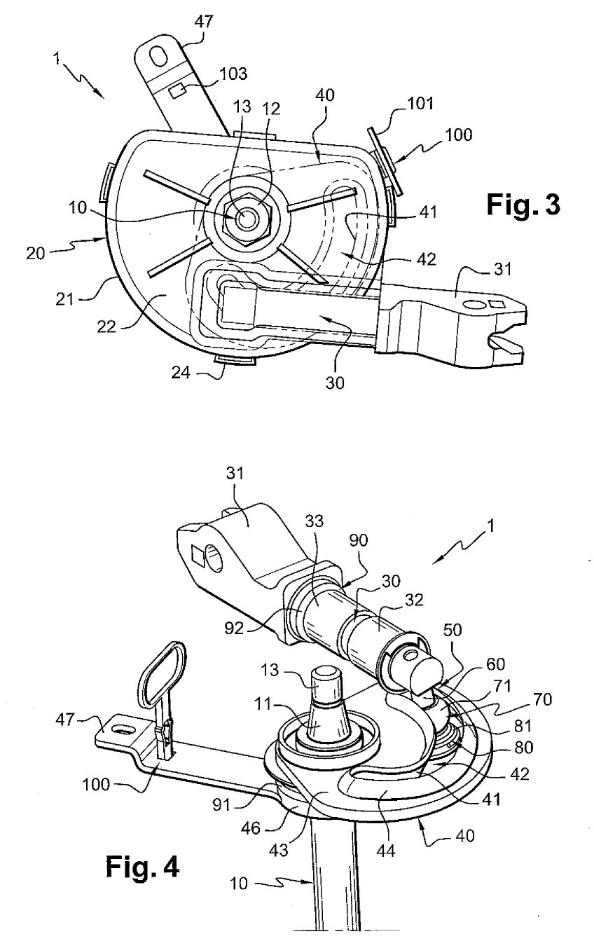

FIG. 4 is a top perspective view showing the relative arrangement of the main components of the rotation control mechanism.

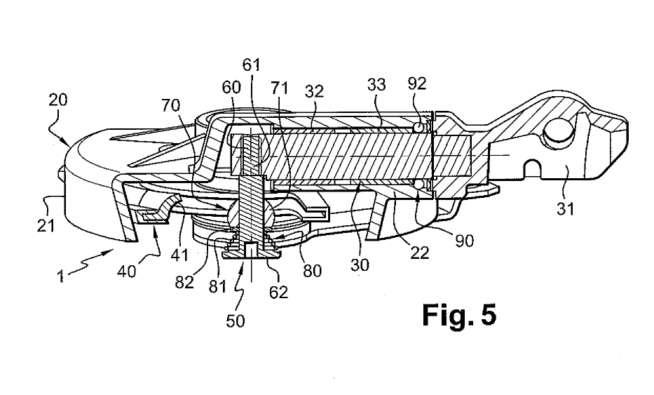

FIG. 5 shows the rotation control mechanism in a cross-section according to a plane passing through the axis of the secondary shaft and the axis of the control element.

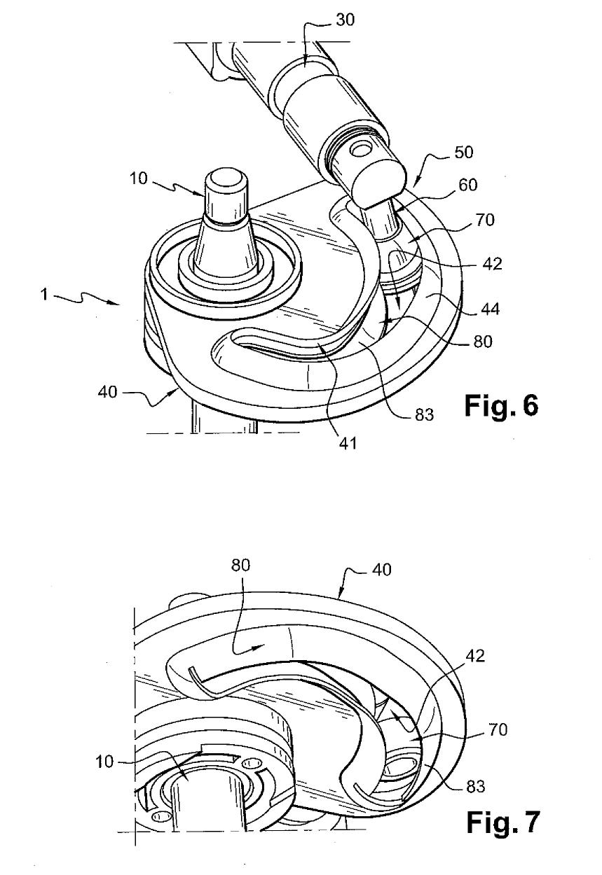

FIG. 6 is a top perspective view showing a variation on the first embodiment of the invention.

FIG. 7 is a view similar to that in FIG. 6, but from a bottom perspective.

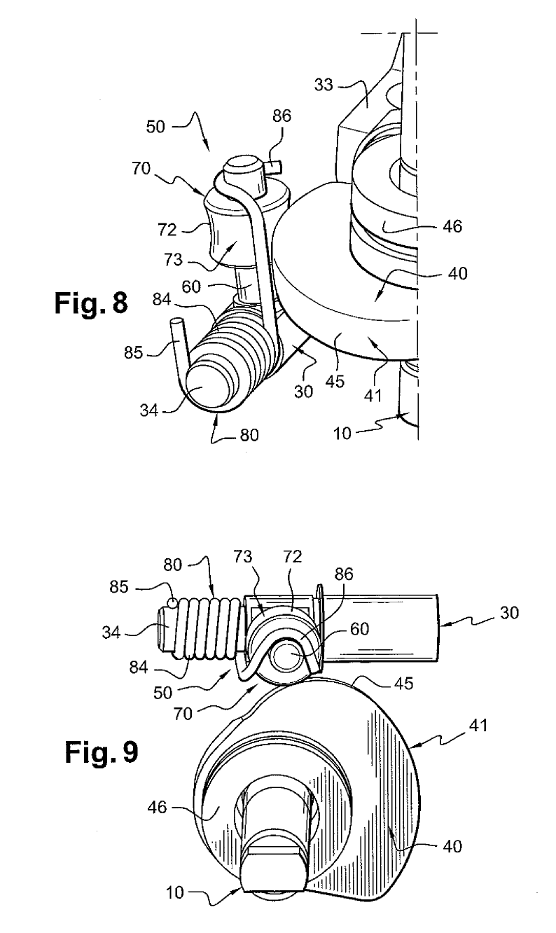

FIG. 8 is a bottom, side perspective view showing a rotation control mechanism according to a second embodiment of the invention.

FIG. 9 is a view similar to that in FIG. 8, but straight on from a bottom perspective.

For reasons of clarity, the same references are used to designate identical elements. Similarly, only the elements which are essential for understanding the invention are shown, without being drawn to scale and in a diagrammatic manner.

FIGS. 1 to 5 show a wiping device intended for equipping a panoramic windscreen of a motor vehicle, including a rotation control mechanism 1 according to a first embodiment of the invention.

It should be noted that the various representations are only partial, in the sense that all the elements that make up the wiping device are not systematically shown for reasons of clarity. This is the case in particular with the motor means, the blade-holding arm and the windscreen-wiper blade assembly.

In any event, according to the aim of the present invention, the rotation control mechanism 1 is equipped first of all with a primary shaft 10 designed to be driven in an alternating axially rotating manner. For this purpose, the primary shaft 10 is furthermore coupled with motor means which in the present case are conventionally made up of an electric motor and gearbox unit.

The rotation control mechanism 1 is then provided with a drive carrier 20 fixed to the primary shaft 10. In this specific embodiment, chosen merely by way of example, the drive carrier 20 is presented concretely in the form of a case 21 made up of a body 22 and a cover 23. The body 22 is fitted onto a tapered part 11 of the primary shaft 10, where it is supported by means of a lock nut 12, screwed onto the end 13 of said primary shaft 10.

The rotation control mechanism 1 also comprises a secondary shaft 30 which is mounted in an axially rotatable manner in relation to the drive carrier 20. In this embodiment, this secondary shaft 30 is positioned substantially perpendicular to the primary shaft 10. Its rotatable mobility is furthermore guided by means of two rings 32, 33 formed integral with the body 22 of the case 21. Finally, the secondary shaft 30 is directly fixed to a rotating head 31 designed to support the blade-holding arm of the wiping device, connectedly mounted.

The rotation control mechanism 1 further comprises a fixed cam 40 having a specific profiled element 41 which depends on the actual curvature of the windscreen surface to be wiped. The cam 40 is immobilised in relation to the rest of the control mechanism 1 by means of a fixing tab 47 designed to be rigidly fixed to the motor vehicle. It is noted that this attachment can be carried out directly by anchoring to the body of the motor vehicle, or indirectly by attaching to the motor means, for example.

The rotation control mechanism 1 finally has a control element 50 fixed to the secondary shaft 30, which can cooperate in a sliding manner with the profiled element 41 of the fixed cam 40, during the relative displacement between the drive carrier 20 and said fixed cam 40. In this example of an embodiment, the control element 50 is positioned substantially perpendicular to the axis of the secondary shaft 30. This means that, at the end it extends substantially coplanar to the axis of the primary shaft 10, regardless of the pivoting angle of the secondary shaft 30.

In any event, the assembly is furthermore arranged so that the sliding of the control element 50 along the profiled element 41 of the fixed cam 40 can control the axial pivoting of the secondary shaft 30.

It should be noted that, in theory, the control element 50 can have any shape and/or structure that allow it to perform its control arm functions.

However, in this example of an embodiment, according to one characteristic of the invention, the control element 50 preferably comprises a lever 60, one end 61 of which is fixed to the secondary shaft 30, a contact element 70 mounted freely in axial rotation on the lever 60, as well as elastic return means 80 which can keep the contact element 70 resting against the profiled element 41 of the fixed cam 40.

According to another characteristic of the invention, implemented in this example of an embodiment, the contact element 70 is furthermore mounted to move in a sliding manner along the lever 60. The main aim of this characteristic is to guarantee the contact between the contact element 70 and the cam profiled element 41, regardless of the angular pivoting value of the secondary shaft 30. Depending on the nature of the control element 50 used, this mobility can be essential for the correct operation of the mechanism, or else be merely incidental with the simple aim of optimisation. In the case of the embodiment shown in FIGS. 1 to 5, its presence is necessary.

In fact, according to a first embodiment of the invention, the contact element 70 which is designed to cooperate in a sliding manner with the cam profiled element 41 consists of a substantially spherical ball-and-socket joint 71. In addition, the corresponding cam profiled element 41 is presented in the form of a groove 42 made sideways through the fixed cam 40.

In a particularly interesting manner, the section of the through groove 42 substantially complements that of the matching portion of the ball-and-socket joint 71. This means, in other terms, that the inner edge of the fixed cam 41, which delimits the through groove 42, has substantially concave walls.

According to an additional characteristic of this first embodiment, the elastic return means 80 can drive the displacement of the ball-and-socket joint 71 along the lever 60 towards a contact position with the profiled element 41 of the fixed cam 40.

In this example of an embodiment, the elastic return means 80 consist concretely of a compression spring 81 one end of which rests against a stop 62 made in the distal part of the lever 60, and the other end of which exerts a pushing force on the sliding ball-and-socket joint 71 by means of an anti-friction washer 82 (FIG. 5).

The sliding assembly of the ball-and-socket joint 71 combined with the action of the compression spring 81 makes it possible to compensate for the geometry variations that appear at the level of the mobile link connecting the secondary shaft 30 and the cam 41 when implementing the rotation control mechanism 1.

The distance between the attachment point of the lever 60 on the secondary shaft 30, on the on hand, and the contact point of the control element 50 on the cam profiled element 41, on the other hand, is not actually constant. It changes as the drive carrier 20 rotates, since the cam profiled element 41 does not extend concentrically in relation to the axis of the primary shaft 10.

And yet, the sliding mobility of the ball-and-socket joint 71 makes it possible precisely to change the length of the lever arm of the control element 50. It is thus possible automatically to adapt this length according to the real separation existing between the point of attachment on the secondary shaft 30 and the contact point on the cam profiled element 41. The role of the compression spring 81 is absolutely complementary, as it consists of guaranteeing, also in an entirely automatic manner, effective contact between the ball-and-socket joint 71 and the cam profiled element 41 when the length of the lever arm of the control element 50 changes.

In this particular example of an embodiment, the cam 40 can actually be seen to have a composite structure. It actually consists of a support part 43 which integrates an insert 44 supporting the profiled element 41. This configuration allows the materials to be chosen according to the actual role of each part of the cam 40.

Naturally however, in a perfectly equivalent manner, it is entirely foreseeable to use a fixed cam 40 presented in the form of a single-piece structure in which the profiled element 41 is directly arranged.

FIGS. 2 and 3 provide better views of the kinematics of the rotation control mechanism 1 as previously described.

FIG. 2 shows that when the wiping device is in fixed stop position, the rotating head 31 is arranged according to a plane with no particular inclination in relation to the axis of the primary shaft 10.

On the other hand, in accordance with FIG. 3, it can be seen that the rotating head 31 is axially tilted by around 25° when the wiping device reaches the opposite fixed stop position, which is to say that the drive carrier 20 has undergone a rotation of little more than 90°.

Between these two end positions—fixed stop and opposite fixed stop—the pivoting of the rotating head 31 does not therefore vary in the linear direction, instead following a clearly defined law dictated by the cam profiled element 41. It is thus that in this example, the head 31 only starts to rotate when the drive carrier 20 has rotated by about 75°, and then continues with acceleration and deceleration phases adapted to the curvature of the associated windscreen.

FIGS. 6 and 7 show a variation on the first embodiment of FIGS. 1 to 5, which is essentially characterised by the particular nature of its elastic return means 80. A spring plate 83 is used in this case to keep the contact element 70 resting against the profiled element 41 of the fixed cam 40.

In practice, this spring plate 83 is fixed along the groove 42, on the face of the cam 40 which is not positioned opposite the secondary shaft 30. It therefore extends substantially symmetrically in relation to the insert 44, and its section substantially complements that of the portion of the ball-and-socket joint 71 which is not inserted in the cam profiled element 41.

The fact that the ball-and-socket joint 71 is ultimately sandwiched between the insert 44 and the spring plate 83, combined with the elastic deformation capacity of said spring plate 83, allows said ball-and-socket joint 71 to remain in contact with the cam profiled element 41 without requiring the use of a compression spring. This therefore means that the ball-and-socket joint 71 is simply mounted in a freely sliding manner along the lever 60.

As for FIGS. 8 and 9, they correspond to a second embodiment of the invention, which is characterised by the fact that the contact element 70 in this case consists of a substantially cylindrical roller 72, while the cam profiled element 41 conventionally consists of the outer circumference 45 of the fixed cam 40. It is understood here that the cylindrical roller 72 can initially have any type of generatrices, which is to say concave, convex or simply straight.

In an additional manner, the roller 72 has a lateral wall 73 with a curvature that substantially complements that of the outer circumference 45 of the fixed cam 40. This is precisely one of the cases in which the generatrices of the cylindrical roller 72 are not strictly straight.

According to another characteristic of this second embodiment, the elastic return means 80 can drive the axial pivoting of the secondary shaft 30 towards a position corresponding to contact between the roller 72 and the profiled element 41 of the fixed cam 40.

In this example of an embodiment, the elastic return means 80 actually consist of a cylindrical spring with angular action 84. This is installed so that its body extends around the proximal end 34 of the secondary shaft 30, one of its ends 85 comes to a stop against the drive carrier 20, and its other end 86 exerts a pushing force on the lever 60 of the control element 50.

Unlike in the previously described first embodiment, the second embodiment has the advantage of not requiring the presence of a system to compensate for distance variations between the secondary shaft 30 and the actual point of contact of the control element 50 on the cam profiled element 41. The roller 72 is actually shaped and sized so as to have a very large contact surface intended to cooperate in a sliding manner with the cam profiled element 41. The concavity and the height of its lateral wall 73 are actually chosen so as to always guarantee contact between the roller 72 of the control element 50 and the fixed cam 40.

According to another characteristic of the invention, the drive carrier 20 is presented in the form of a case 21 which contains the fixed cam 40 and the control element 50. This implies initially that the assembly is arranged so that the primary shaft 10 and the secondary shaft 30 penetrate the case 21. However, since the fixed cam 40 is designed to remain immobile in relation to the rest of the control mechanism 1, this also implies that the assembly is arranged so that the case 21 can turn despite the presence of the fixed cam 40 inside it.

This characteristic makes it possible to group the essential components of the control mechanism 1 together inside a case that is relatively protected against dirt and other external elements. This therefore provides considerable improvements, in particular as regards the reliability and useful life of the rotation control mechanism 1.

In this example of an embodiment, the case 21 consists of a hollow body 22 whose opening is blocked by a cover 23. These two elements are joined together in a detachable manner. For this purpose, the cover 23 is provided with four elastically deformable tabs 24, distributed on each of its sides, which can be inserted after deformation in bosses 25 arranged in a suitable manner on the outer surface of the body 22.

As can be seen in FIGS. 4 and 5, the case 21 is furthermore equipped with sealing means 90 which can improve its watertightness at the areas where the mobile shafts 10, 30 are installed. A notable aspect is the presence of a first O-ring 91 positioned between the body 46 of the cam 40 and the cover 23, as well as a second O-ring 92 positioned between the secondary shaft 30 and the body 22 of the case 21.

According to another special feature of the invention, the control mechanism 1 is also equipped with indexing means 100 which can immobilise the drive carrier 20 in a reversible manner in relation to the fixed cam 40 (FIGS. 1 to 4). This characteristic makes it possible temporarily to block its various mobile parts during the transport and storage phases, and to do so until the final assembly of the wiping device on the motor vehicle for which it is intended.

In this particular embodiment, chosen merely by way of example, the indexing means 100 comprise a pin 101, the body of which becomes housed in a holding housing 102 made in the cover 23, and the distal end of which can be inserted in a blocking hole 103 made through the fixing tab 47.

Naturally however, any other blocking system known in the state of the art can also be used in an equivalent manner.

More generally, the invention also relates to any other wiping device comprising motor means capable of generating an alternating rotating movement, as well as a blade-holding arm on the end of which is mounted a windscreen-wiper blade assembly, also comprising a rotation control mechanism 1 as previously described, the motor means being coupled with the primary shaft 10 while the blade-holding arm is fixed to the secondary shaft 30.

However, even more generally, the invention also relates to any motor vehicle equipped with at least one wiping device such as previously described.

1. A rotation control mechanism, comprising:
a primary shaft configured to be driven in an alternating axially rotating manner;
a drive carrier fixed to the primary shaft;
a secondary shaft mounted in an axially rotatable manner in relation to the drive carrier;
a fixed cam provided with a specific profiled element; and
a control element which is fixed to the secondary shaft and configured to cooperate in a sliding manner with the cam profiled element during the displacement of the drive carrier in relation to the fixed cam,
wherein the sliding of the control element along the cam profiled element controls the axial pivoting of the secondary shaft.

2. The control mechanism (1) according to claim 1, wherein the control element comprises:
a lever, one end of which is fixed to the secondary shaft;
a contact element mounted freely in axial rotation on the lever;
elastic return means configured to keep the contact element resting against the profiled element of the fixed cam.

3. The control mechanism according to claim 1, wherein the contact element is mounted to move in a sliding manner along the lever.

4. The control mechanism according to claim 2, wherein the contact element is made up of a substantially spherical ball-and-socket joint, and wherein the cam profiled element is presented in the form of a groove made sideways through the fixed cam.

5. The control mechanism according to claim 4, wherein the section of the groove substantially complements that of the matching portion of the ball-and-socket joint.

6. The control mechanism according to claim 4, wherein the elastic return means can drive the displacement of the ball-and-socket joint along the lever towards a contact position with the cam profiled element.

7. The control mechanism according to claim 2, wherein the contact element comprises a substantially cylindrical roller, and wherein the cam profiled element is the outer circumference of the fixed cam.

8. The control mechanism according to claim 7, wherein the cylindrical roller has a lateral wall with a curvature that substantially complements that of the outer circumference of the fixed cam.

9. The control mechanism according to claim 7, wherein the elastic return means can drive the axial pivoting of the secondary shaft towards a contact position between the cylindrical roller and the cam profiled element.

10. The control mechanism according to claim 1, wherein the drive carrier comprises a case which includes the fixed cam and the control element.

11. The control mechanism according to claim 10, the case comprises sealing means which can seal the primary shaft and the secondary shaft pass through.

12. The control mechanism according to claim 1, further comprising:
indexing means configured to immobilise the drive carrier in a reversible manner in relation to the fixed cam.

13. A wiping device comprising:
motor means which can generate an alternating rotating movement;
a blade-holding arm on the end of which is mounted a wiping blade assembly; and
a rotation control mechanism according to claim 1, wherein the motor means are coupled with the primary shaft, and wherein the blade-holding arm is fixed to the secondary shaft.

14. The wiping device of claim 13, wherein the wiping device is part of a motor vehicle.
